(19) United States
(12) Patent Application Publication
(10) Pub. No.: US 2001/0003500 A1
(43) Pub. Date: Jun. 14, 2001

(54) Electrical protection relay

(76) Inventors: Alain Cheze, Creteil (FR); Bernard Macor, Wambercourt (FR)

Correspondence Address: Smith, Gambrell & Russell, LLP, Beveridge, DeGrandi, Weilacher & Young, Intellectual Property Group, 1850 M Street, N.W., Suite 800, Washington, DC, 20036, US

(21) Appl. No.: 09/729,861

(22) Filed: Dec. 6, 2000

(30) Foreign Application Priority Data
Dec. 8, 1999 (FR) 9915489

(51) Int. Cl. H02H 5/04; H02H 7/08; H02H 9/00

(52) U.S. Cl. 361/93.1; 361/93.6; 361/31; 361/57; 361/42

(57) ABSTRACT

Electrical protection device for a railroad vehicle, including electrical energy consuming units 6, 7 and electrical power supply means 1 to 5, electrical energy being supplied on at least two liner electrically separated from the ground formed by the vehicle as a whole, in particular its chassis and the electrically conductive parts connected to it. The electrical protection device includes detector means 50 for detecting a short circuit alternating current flowing from one of the two power supply lines to ground, to detect any short circuit between the other power supply line and ground.

The invention relates to the field of electrical protection of railroad power vehicles adapted to be supplied with power by an alternating current supply.

A railroad vehicle, such as a locomotive, supplied with power by a single-phase 25 000 V network includes a stepdown transformer which has one or more secondaries with a normal voltage of 1 500 V. This is known in the art. The transformer is disposed in the middle of the motor car and there are many cables near it. In the event of an incident, and in particular a disruptive discharge to the ground of the vehicle, a contactor in the motor unit connected to an output of the 1 500 V secondary cuts off the power supply to the motor unit. The secondary of the transformer is still live, however. If the disruptive discharge occurs on the input side of the contactor, it continues and is not detected by the present system. In this case there is the risk of burning out a motor unit or even the entire rotor car.

The protection device used at present to protect against accidental grounding of the traction circuit consists of a relay biased by the positive pole of the battery of the motor unit and connected to tho cold point of the traction circuit. The negative pole of the battery is connected to ground via a resistor and a disruptor. This system operates in most cases but does not detect disruptive discharges caused by an AC voltage.

An object of the present invention is to remedy the problems referred to above.

An object of the present invention is to propose an electrical protection device suitable for vehicles supplied with power by an alternating current.

The electrical protection device according to the invention is intended for a railroad vehicle including units consuming electrical energy, electrical energy being supplied to the motor unit or units on two lines electrically separated from the ground of the vehicle (the chassis and all electrically conductive parts connected to it).

The protection device includes means for detecting AC disruptive discharges on the power supply lines. It is therefore possible to detect grounding of a hot point or a cold point of the circuit. By “cold point” is meant a point of a line connected to the secondary of the power supply transformer and connected to the vehicle ground via a resistor, for example. In contrast, a hot point is not connected to the vehicle ground and is connected to the other terminal of the secondary of the transformer.

In one embodiment of the invention, the alternating current detector means include a transformer whose secondary is connected to a relay via a rectifier bridge, the primary of the transformer being connected in series with a resistor between the power supply line and ground. The power supply line becomes the cold point of the traction circuit. A capacitor can be provided at the output of the secondary of the transformer. That capacitor filters any spurious frequencies, in particular if a chopper is used in the electrical power supply system.

In one embodiment of the invention a resistor is connected to said power supply line in parallel with the alternating current detector means. The resistance of the resistor determines the sensitivity of the alternating current detector means.

In one embodiment of the invention means for detecting a short circuit direct current flowing from said power supply line to ground are connected in series with the alternating current detector means. In this way it is possible to detect a short-circuit between said power supply line and ground.

In one embodiment of the invention said power supply line is connected to ground via an impedance, preferably a resistor or a capacitor.

In one embodiment of the invention said power supply line is connected to ground via a battery in series with a contactor.

The battery is advantageously connected in parallel with a first impedance and in series with a second impedance.

In one embodiment of the invention the alternating current detector means are adapted to detect an alternating current above a predetermined threshold as soon as the first cycle crosses said threshold.

The alternating current detector means are preferably connected to control means for isolating energy consuming units, for example of a motor unit or one of the vehicles in the case of coupled vehicles, and if a connection to ground is detected again after isolating a motor unit. Means can also be provided to prevent return of the vehicle to service by inhibiting the power supply means.

In one embodiment of the invention the power supply means are alternating current power supply means. The power supply means can include a transformer whose secondary is electrically separated from the ground formed by the vehicle as a whole.

In another embodiment of the invention the power supply means are direct current power supply means.

The present invention will be understood better after studying the detailed description of one embodiment given by way of non-limiting example only and illustrated by the accompanying drawings, in which:

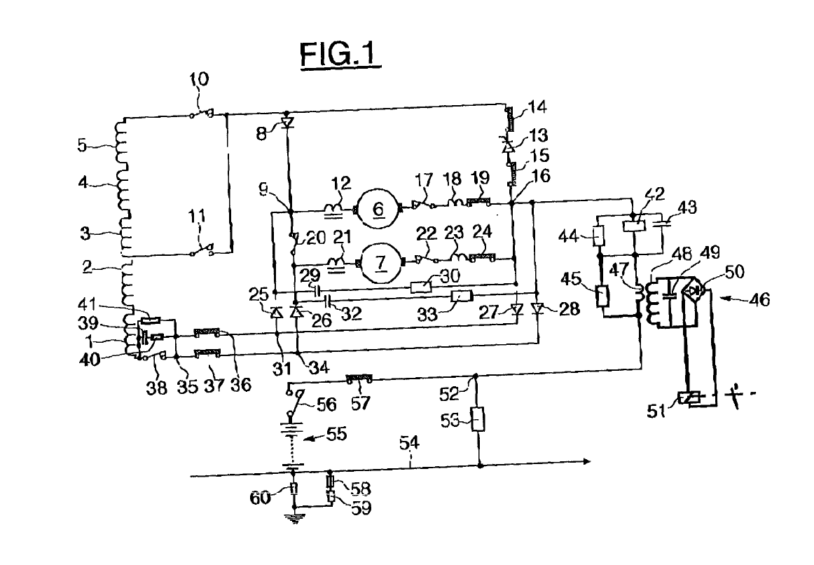

FIG. 1 is a circuit diagram showing the installation of a protection device in the electrical circuit of a vehicle, and

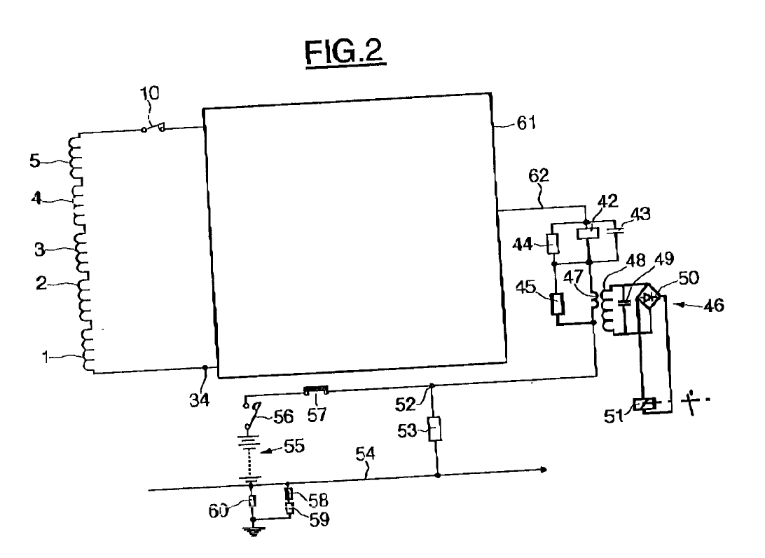

FIG. 2 is a simplified diagram of the device shown in FIG. 1.

Only a secondary of the power supply transformer is shown and is designed to supply power to energy consuming units of a motor bogie. The secondary is divided into five parts 1 to 5 so that voltages can be tapped off equal to fractions of the total secondary voltage. The motor bogie can include two traction motors 6 and 7. The motors 6 and 7 are supplied with power via a mixed thyristor bridge. The thyristor 8 of the top half-bridge is disposed between the top output of the secondary 5 and the point 9 to which the motors 6 and 7 are connected.

A single-phase power supply contactor 10 of the motor unit is connected between the top output of the secondary 5 and the thyristor 8. Another contactor 11 is connected between the top output of the secondary 2 and the thyristor 8 to enable operation at a reduced voltage. A smoothing choke 12 is connected between the point 9 and the motor 6. The other branch of the top half-bridge includes a thyristor 13 and two isolators 14 and 15 disposed on respective opposite sides of the thyristor 13. The thyristor 14 [sic] is connected to the contactors 10 and 11 for the power supply and the isolator 15 is connected to a point 16. A contactor 17, the inductors 18 and an isolator 19 are connected between the other terminal of the motor 6 and the point 16. The motor 7 is also connected to the point 9 via a contactor 20 and a smoothing choke 21. The other terminal of the motor 7 is connected to the point 16 via a contactor 22, an inductor 23 and an isolator 24.

The bottom half-bridge includes four diodes 25, 26, 27 and 28. The diode 25 has one terminal connected directly to the point 9 and also connected to the point 16 via a capacitor 29 and a resistor 30. The other terminal is connected to a point 31. The diode 26 has one terminal connected to the common point of the contactor 20 and the current sensor 21 and also connected to the point 16 via a capacitor 32 and a resistor 33. Its other terminal is connected to a point 34. The diode 27 has one terminal connected directly to the point 16 and the other terminal connected directly to the two point 31. The diode 28 has one terminal connected directly to the point 16 and the other terminal connected directly to the point 34.

The point 31 is connected to a point 35 via an isolator 36. The point 34 and the point 35 are connected together via an isolator 17.

The point 35 is connected to the bottom output of the secondary 1 by three parallel branches, the first of which includes a contactor 38, the second of which includes an RC circuit comprising a capacitor 39 and a resistor 40, and the third of which includes a resistor 41.

The points 31 and 34 form what is referred to as a “cold point”, i.e., a point connected to the vehicle ground, and the lines connecting the thyristor 8 and the isolator 14 to the contactors 10 and 11 form a hot point, i.e. a point exposed to high voltage.

The point 16 is connected to a relay 42 which is shunted by a capacitor 43 and a resistor 44. A resistor 45 and a relay system 46 are connected to the terminal of the relay 42 not connected to the point 16.

The relay system 46 includes a current transformer with a primary 47 shunting the resistor 45 and a secondary 48 whose terminals are connected to a capacitor 43 and a rectifier bridge 50 connected in parallel. A relay 51 is provided at the output of the rectifier bridge 50. The resistor 45 and the relay system 46 are connected to a point 52 on the opposite side of the relay 42. The point 52 is connected to a resistor 53 whose other terminal is connected to a line 54 which can be common to several vehicles. The resistor 53 fixes the potential of the main transformer at ground potential. The point 52 is also connected to the batteries 55 of the vehicle via a battery contactor 56 and an isolator 57. The point 52 is connected to the positive pole of the batteries 55, whose negative pole is connected to the line 54. Finally the line 54 is connected to the mechanical ground of the vehicle via a resistor 60 which is shunted by an indicating battery ground MCB 58 and a resistor 59. The resistors 60 and 59 fix ground potential at the potential at the negative terminal of the batteries 55.

If a cold point, for example the point 34, is accidentally connected to the mechanical ground of the vehicle, the current flowing is detected by the relay, which could initiate the appropriate isolation. However, if a hot point is connected to ground, the alternating current flowing into the relay 42 prevents it operating correctly and as a result the grounding is not detected and there is a risk of fire. On the other hand, the galvanic isolation provided by the current transformer of the relay system 46, with its primary 47 and its secondary 48, and the rectifier bridge 60 enables the relay 51 to operate and therefore to bring about the necessary isolation, for example by actuating the contactor 10.

The relay 42 is supplied with power by the batteries 55 as soon as the driver of the vehicle selects a direction of motion by closing the contactor 56. The relay 42 is connected at the output to the cold point 52 of the power circuit. The function of the relay 42 is to detect a connection to ground on the power circuit of the motor unit in the traction phase and to open a single-phase circuit-breaker and isolate the motor unit, in a braking or coasting phase, to isolate the motor unit, and in a stopped phase to fix the potential of the secondaries of the transformer via the resistor 53 if the braking traction isolator 14 is set to braking or costing.

In the traction phase, and assuming that a hot point is connected to ground, the relay 42 is exposed to the AC output voltage of the secondary of the main transformer via the ground and principally via the resistors 60 and 59, the MCB 58 and the batteries 55. The resistor 53 is in parallel with the batteries 55 and the combination of the resistors 60 and 59 and the MCB 58. The relay 42 is also exposed to the DC voltage of the batteries 55 which is connected to the traction circuit ground and returns to the negative pole of the battery via the combination of the resistors 60 and 59 and the MCB 58.

In the event of a connection to ground on the cold point side, the relay 42 is exposed to a zero AC voltage and to the DC voltage of the batteries 55 which is connected to the traction circuit ground and returns to the negative pole of the batteries via the combination of the resistors 60 and 59 and the MCB 58.

During braking, and in the event of a connection to ground on the hot point side of the circuit, the relay 42 is exposed to the DC voltage (approximately 1 000 V) supplied by the electric motor 6 or 7 under stabilized operating conditions via ground, principally via the resistors 60 and 59, the MCB 58 and the batteries 55 shunted by the resistor 53. The voltage of the batteries 55 is added to that of the motor 6 or 7 functioning as a generator. In the event of a connection to ground on the cold point side of the circuit, the relay 42 is exposed to the DC voltage of the batteries 55 which is connected to the ground of the circuit and returns to the negative pole of the batteries via the resistors 60 and 59 and the MCB 58.

The relay 42 is inactive when in service or when entering service because the contactor 56 is open. When operating in traction, and in the event of a connection to ground of a hot point, the coil of the relay 42 must supply a power of approximately 900 W until the circuit-breaker opens, which takes approximately 100 ms. During this time, the resistor 44 has to dissipate a power of 3 850 W, which is greater than its nominal power rating. Moreover, if the connection to ground continues after the main circuit-breaker closes again, this power is drawn continuously, despite the isolation of the motor unit, because the relay 42 is no longer effective in opening the circuit-breaker since its contact is shunted by the break auxiliary contact of the contactor 17 or of the contactor 22. The consequences of this failure to respond to faults can be as serious as a fire in the motor car.

If a hot point is connected to ground during braking, the resistor 44 must dissipate a power of approximately 440 W until a relay trips to isolate the motor, which can take approximately 200 ms. During this time, the resistor 44 is called upon to dissipate a power of 1 960 W. There is nothing to prevent the isolated motor unit from being returned to service from the driver's cab, which can operate the relay 42 again. If the connection to ground remains after the main circuit-breaker closes again, the relay 42 must withstand this power continuously, despite the isolation of the motor unit. The relay 42 is no longer effective in opening the circuit-breaker because its contact is shunted by the break contact of the contactor 17 or the contactor 22.

According to the invention, the relay system 46 prevents the drawbacks just described. The relay system 46 includes a capacitor 49 which has a capacitance of 2.2 μF, for example, and which filters spurious frequencies at the terminals of the secondary 48, typically frequencies of 300 Hz and 600 Hz generated in the circuit by the main choppers during the braking phase. The resistor 45 shunting the primary 47 is used to vary the current at which the system trips. It can be adjusted to a value of 47 Ω, for example.

The specifications of the resistor system 45 and the relay system 46 at 50 Hz are as follows.

impedance: 22 Ω

rectified secondary voltage: 6.7 V

tripping threshold, primary current only: 58 mA

rectified secondary voltage: 3.3 V

In the event of an AC connection to ground at a hot point, for example between the contactor 10 and the isolator 14 or between the contactor 10 and the thyristor 8, the leakage current to ground flows through the primary 47 of the current transformer of the relay system 46 and the relay 51 causes the motor unit to be isolated. If the connection to ground reappears, and the main circuit-breaker trips out again, or persists, after the motor unit is isolated, the main circuit-breaker no longer being open in the case of a motor unit under braking or coasting or isolated, the main circuit-breaker is opened by commanding the isolating relay of a vehicle roof isolator, the high-voltage isolator will be isolated by an isolating relay, and the closure of the circuit-breaker in the vehicle will be locked to prevent any use of said vehicle in the event of maneuvering a pantograph control switch. The system can be rearmed by pressing a common unit isolation cancel pushbutton.

Thus in the event of detection of an AC connection to ground, the relay system 46 trips and commands a substitute relay, not shown, adapted to be controlled by the relay 42 and the relay 51. After the motor unit is isolated the relay system 46 trips again and arms a timer, not shown, which is set to a time-delay of 0.25 s and which triggers an actuator which commands the main circuit-breaker, isolation of the aforementioned high-voltage isolator by an isolating relay, isolation of the main circuit-breaker from the motor car in which the ground fault has occurred by a main circuit-breaker isolating bistable relay preventing use of the vehicle even in the event of operation of a pantograph control switch, and signaling from the MCB 58 to the common unit.

FIG. 2 shows a system 61 combining the motor units, protection and associated bridges. The system 61, which forms an energy consuming unit, is supplied with power from the two terminals of the secondary via the contactor 10. An output 62 is connected to the relay 46 and to the relay system 50, as previously explained. The output 62 can be taken from one terminal of a motor.

The invention protects and monitors the motor unit and the secondaries of the transformer as soon as the vehicle is live with alternating current in traction, braking, coasting, out of use, in service or with the motor unit isolated by a motor isolating relay or a motor unit isolating switch. This avoids significant damage to or even complete destruction of a vehicle if a hot point of the circuit is connected to ground.

1. An electrical protection device for protecting a railroad vehicle, including electrical energy consuming units (6, 7) and electrical power supply means (1 to 5), electrical energy being supplied to the energy consuming units on two lines electrically separated from the vehicle ground, characterized in that it includes means for detecting an AC disruptive discharge on the power supply line.

2. A device according to claim 1, characterized in that the alternating current detector means include a transformer whose secondary is connected to a relay (51) via a rectifier bridge and the primary of the transformer is connected in series between a power supply line and ground via a resistor.

3. A device according to claim 2, characterized in that a capacitor (49) is connected to the output of the secondary of the transformer.

4. A device according to any preceding claim, characterized in that a resistor (45) is connected to said power supply line in parallel with the alternating current detector means.

5. A device according to any preceding claim, characterized in that detector means (42) for detecting a short circuit direct current flowing in said power supply line towards ground are connected in series with the alternating current detector means.

6. A device according to any preceding claim, characterized in that said power supply line is connected to ground via an impedance.

7. A device according to any preceding claim, characterized in that said power supply line is connected to ground via a battery (55) in series with a contactor (56).

8. A device according to either claim 6 or claim 7, characterized in that the battery is connected in parallel with a first impedance (53) and in series with a second impedance (57).

9. A device according to any preceding claim, characterized in that the alternating current detector means are adapted to detect an alternating current greater than a predetermined threshold during the first cycle crossing said threshold.

10. A device according to any preceding claim, characterized in that the alternating current detector means are connected to means for commanding isolation of said energy consuming units.

11. A device according to any preceding claim, characterized in that the power supply means are alternating current power supply means.

12. A device according to any of claims 1 to 10, characterized in that the power supply means are direct current power supply means.
